(19) United States
(12) Patent Application Publication
(10) Pub. No.: US 2009/0118000 A1
(43) Pub. Date: May 7, 2009

(54) Gaming Machine And Gaming System

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp.

(21) Appl. No.: 12/019,960

(22) Filed: Jan. 25, 2008

Related U.S. Application Data
(60) Provisional application No. 60/984,571, filed on Nov. 1, 2007.

(51) Int. Cl. A63F 13/00

(52) U.S. Cl. 463/27

(57) ABSTRACT

Gaming machines constituting a gaming system share a progressive jackpot. The progressive jackpot award amount increases by incrementing a certain portion of bets betted on the game being conducted in each of the gaming machine. The progressive jackpot award amount increasing in such manner is displayed on a liquid crystal panel 5B of each of the gaming machines. The liquid crystal panel 5B is divided into a window W1 and a window W2. The window W1 is provided with an award amount display portion 6 for displaying the progressive jackpot award amount. The window W1 further displays any one of fish characters 5A, 5B, and 5C, in accordance with the progressive jackpot award amount.

### CROSS-REFERENCE TO THE RELATED APPLICATION(S)

This application is based upon and claims a priority from the U.S. provisional Patent Application No. 60/984,571 filed on Nov. 1, 2007, the entire contents thereof are incorporated herein by reference.

### BACKGROUND OF THE INVENTION

1. Field of the Invention

The present invention relates to a gaming machine and gaming system in which a progressive jackpot award amount is displayed.

2. Description of Related Art

Heretofore, conventional gaming machines and gaming systems are disclosed in U.S. Pat. No. 5,645,486 and US Patent Application Publication No. 2004/023553, in which award to be paid out to a result of a specific game is increased by incrementing a predetermined amount deducted from money betted.

Such system is hereinafter referred to as “progressive jackpot”.

A progressive jackpot award amount is displayed in numeral. Such display manner only allows a player to confirm the progressive jackpot award amount by reading the numeral shown on the display or to confirm that the progressive jackpot award amount has increased by seeing the increase in the numeral shown on the display.

### SUMMARY OF THE INVENTION

The present invention has been conceived in view of the above circumstance and its object is to provide a gaming machine and gaming system in which a progressive jackpot award amount is displayed in a new manner.

Therefore, in order to achieve the object, according to a first aspect of the present invention, there is provided a gaming machine comprising: an operation device for carrying out bet operation on a game; a display in which a progressive jackpot award amount and a character are displayed in pair; and a processor programmed to carry out operations of: (a) incrementing the progressive jackpot award amount in accordance with number of bets betted with the operation device; and (b) changing the character displayed on the display in accordance with the progressive jackpot award amount, which has been incremented at (a).

Furthermore, according to other aspect of the present invention, there is provided a gaming system, comprising: a plurality of gaming machines each of which includes: an operation device for carrying out bet operation on a game; and a display in which a progressive jackpot award amount and a character are displayed in pair; and a server that configures each of the plurality of gaming machines to share the progressive jackpot, the server being programmed to carry out operations of (a) incrementing the progressive jackpot award amount in accordance with number of bets betted in each of the plurality of gaming machines by using the operation device; (b) changing the character displayed on the display of each of the plurality of gaming machines, in accordance with the progressive jackpot award amount, which has been incremented at (a).

Furthermore, according to other aspect of the present invention, there is provided a gaming system, comprising: a shared display; a plurality of gaming machines each of which includes: an operation device for carrying out bet operation on a game; and a display in which a progressive jackpot award amount and a character are displayed in pair; and a server that configures each of the plurality of gaming machines to share the progressive jackpot, the server being programmed to carry out operations of (a) incrementing the progressive jackpot award amount in accordance with number of bets betted in each of the plurality of gaming machines by using the operation device, (b) changing the character displayed on the display of each of the plurality of gaming machines, in accordance with the progressive jackpot award amount, which has been incremented at (a), and (c) displaying the progressive jackpot award amount, which has been incremented at (a), and the character, which has been changed at (b), in pair onto the shared display.

### BRIEF DESCRIPTION OF THE DRAWINGS

FIG. 1 is a diagram for illustrating a feature of gaming system according to one embodiment of the present invention;

FIG. 2 is a system block diagram showing the gaming system;

FIG. 3 is an external perspective view of a gaming machine;

FIG. 4 is a block diagram showing an internal configuration of the gaming machine;

FIG. 5 is a block diagram showing an internal configuration of the sub-control board;

FIG. 6 is a view showing one example of images to be displayed in a liquid crystal panel;

FIG. 7 is a view showing one example of images to be displayed in the liquid crystal panel;

FIG. 8 is a view showing one example of images to be displayed in the liquid crystal panel;

FIG. 9 is a view showing one example of images to be displayed in the liquid crystal panel;

FIG. 10 is a view showing one example images to be displayed in a shared display and the liquid crystal panel of the gaming machines in the gaming system;

FIG. 11 is a table for illustrating correspondences between progressive jackpot award amounts and fish characters;

FIG. 12 is a flowchart of a main control program;

FIG. 13 is a flowchart of a main game processing program;

FIG. 14 is a flowchart of a control program executed in the gaming machine and a game server;

FIG. 15 is a flowchart of a control program executed in the gaming machines;

FIG. 16 is a view showing one example of images displayed in the shared display and the liquid crystal panel of the gaming machines in the gaming system;

FIG. 17 is a table for illustrating correspondences between progressive jackpot award amounts and bug characters.

### DETAILED DESCRIPTION OF THE PREFERRED EMBODIMENTS

[1. General Description of the Invention]

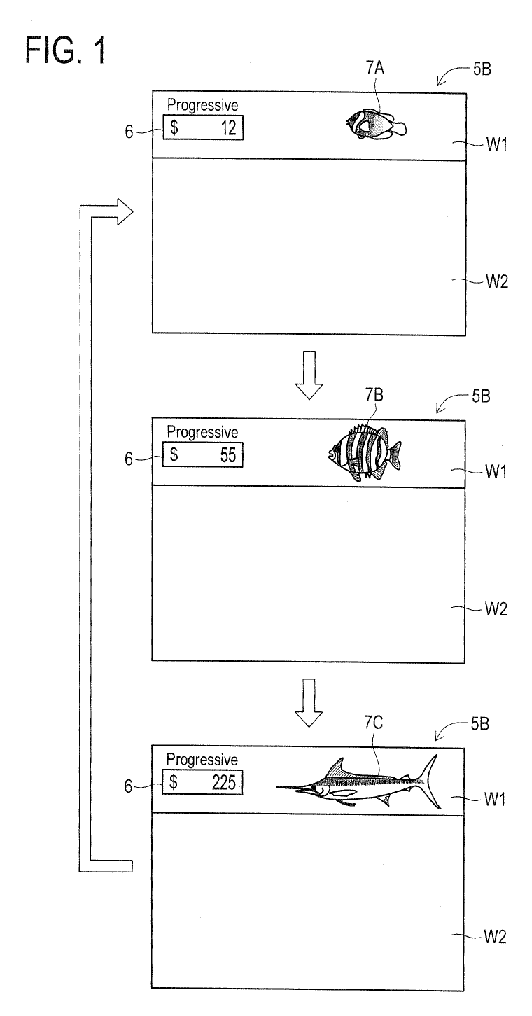

Embodiments of the present invention will be explained by referring to the drawings. A gaming system of the present embodiment includes a plurality of gaming machines. A progressive jackpot award amount and a character are displayed in a pair on a display of the individual gaming machines. FIG. 1 is a diagram for illustrating a feature of gaming system according to one embodiment of the present invention.

The gaming machines constituting the gaming system of the embodiment share a progressive jackpot. The progressive jackpot award amount increases by incrementing a predetermined portion of the number of bets betted on a game conducted in the individual gaming machines.

The progressive jackpot award amount increasing in this way is displayed on a liquid crystal panel 5B of the gaming machine, as shown in FIG. 1. A screen of the liquid crystal panel 5B is divided into a window W1 and a window W2. The window W1 is provided with an award amount display portion 6.

The window W1 further displays any one of fish characters 7A, 7B, and 7C. The fish character 7A represents “yellow-tailed anemone fish”, which is displayed on the window W1 when the numeral displayed on the award amount display portion 6 (progressive jackpot award amount) is $49 or less. The fish character 7B represents “parrot fish”, which is displayed on the window W1 when the numeral displayed on the award amount display portion 6 (progressive jackpot award amount) is $50 or more and $199 or less. The fish character 7C represents “blue marlin”, which is displayed on the window W1 when the numeral displayed on the award amount display portion 6 (progressive jackpot award amount) is $200 or more.

The window W2 of the liquid crystal panel 5B displays an image concerning state of a game being conducted in the gaming machine.

[2. Schematic Structure of the Gaming System]

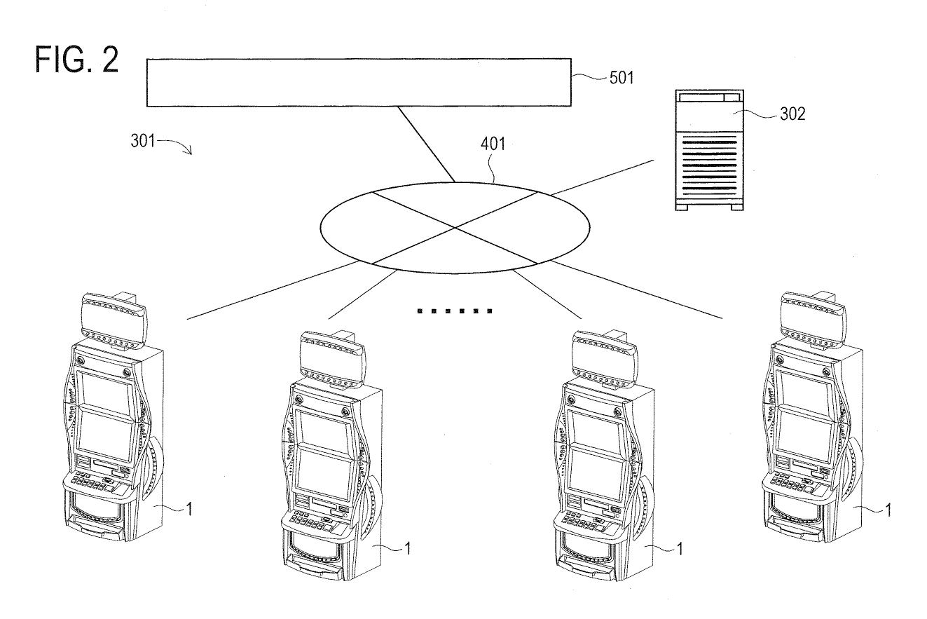

FIG. 2 is a system block diagram showing the gaming system of the present embodiment. As shown in FIG. 2, a gaming system 301 of the present embodiment includes a network 401 of two-way communicable through which a shared display 501, a game server 302 and a plurality of gaming machines 1 are connected.

[3. Schematic Structure of the Gaming Machine]

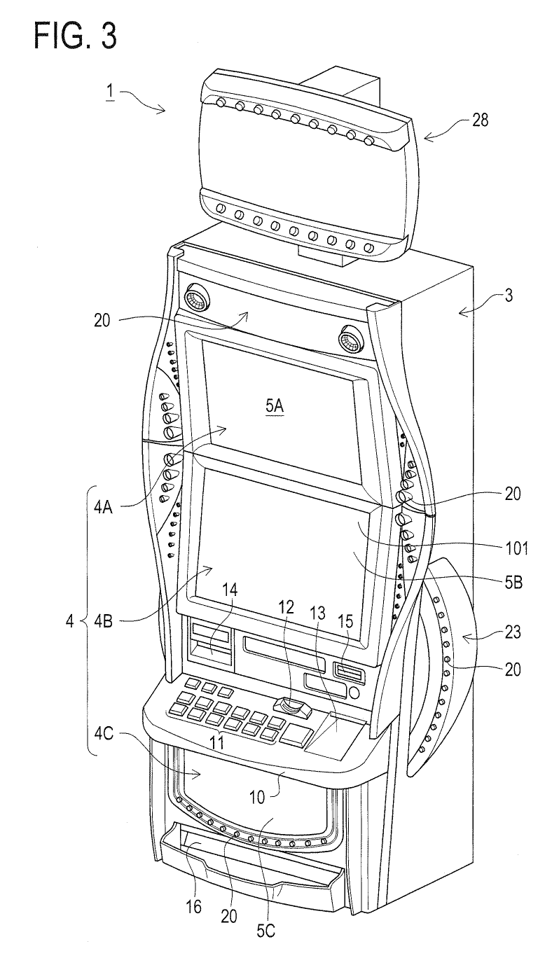

Next, a schematic structure of the gaming machine 1 will be described by referring to FIG. 3. FIG. 3 is an external perspective view of the gaming machine 1.

As shown in FIG. 3, the gaming machine 1 is of an upright type which is equipped with a game arcade such as casino and includes a cabinet 3 for housing electric or mechanical parts for conducting predetermined types of games. A display unit 4 for displaying information related to a game includes, for example, an upper display unit 4A, a variable display unit 4B at the middle stage of the display unit 4, and an under display unit 4C, which are installed at the front face of the cabinet 3 in a vertically long shape. The upper display unit 4A includes the liquid crystal panel 5A arranged at the upper side of the variable display unit 4B, the liquid crystal panel 5A for displaying an effecting images, an introduction of a game, or an explanation of game rules and the like. The under display unit 4C is arranged at the lower side of the variable display unit 4B and includes a plastic panel 5C on which an image is printed. The plastic panel 5C is lighted up with the backlight of the under display unit 4C.

The variable display unit 4B for displaying a state of a game includes the liquid crystal panel 5B which is fixed at a front door of the cabinet 3. The front face of the liquid crystal panel 5B includes a touch panel 101, with which a player can input various commands. The variable display unit 4B at the middle stage of the cabinet 3 is sloped so that the head of the variable display unit 4B tilts back to thereby allow the player to play a game in a comfortable position.

An operation table 10 extending forward is provided in between the variable display unit 4B at the middle stage and the under display unit 4C, on a front face of the cabinet 3. On the operation table 10, there are arranged operation buttons 11 including a BET button, a game start button, a collect button, a CASHOUT button and the like as an operation part for inputting instructions concerning a game conducted. The operation table 10 is provided with a coin insertion slot 12 and a bill insertion slot 13. A ticket printer 14 and a card reader 15 are provided in between the operation table 10 and the variable display unit 4B at the middle stage. The lowermost part of the cabinet 3 is provided with a coin tray 16.

As to the gaming machine 1, coins, bills or electronic value information (credit) corresponding to coins and bills are used as gaming media. However, in the present invention, types of gaming media are not restricted to the above. For example, medal, token, electronic money, ticket and the like are applicable as gaming media.

There are also arranged light emitting portions 20 on the cabinet 3 of the gaming machine 1 so as to surround a game area including the upper display unit 4A, the variable display unit 4B at the middle stage, the under display unit 4C and the operation table 10.

The gaming machine 1 is further provided with a topper effect device 28 mounted on the cabinet 3. The topper effect device 28 is of a rectangular board shape and is arranged so as to be substantially parallel with the liquid crystal panel 5A of the upper display unit 4A. The cabinet 3 is further provided with speakers 23 on its both sides.

[4. Internal Configuration of the Gaming Machine]

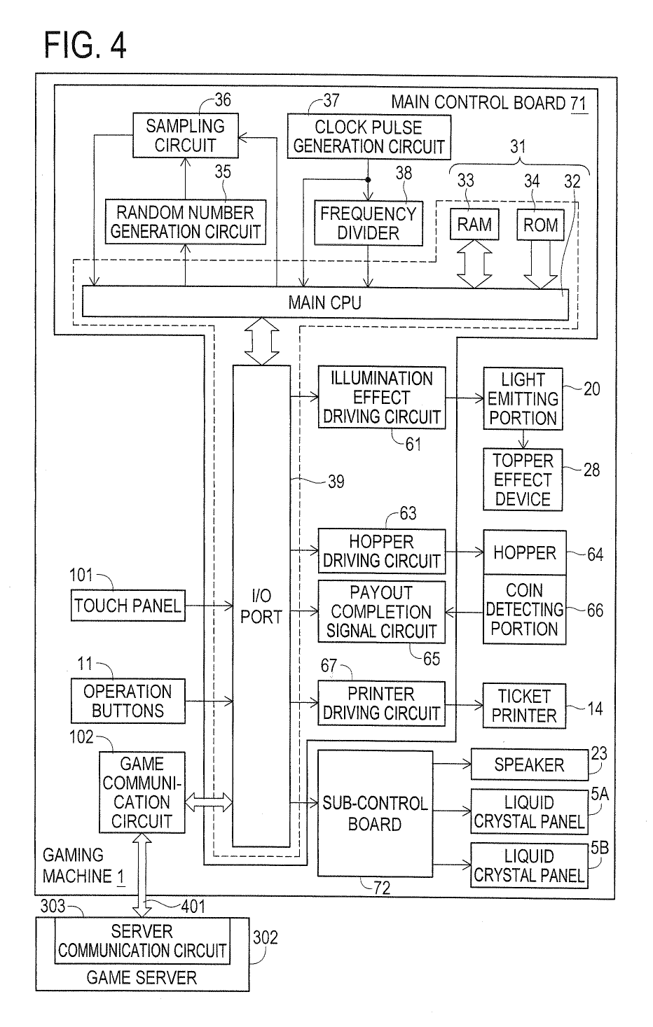

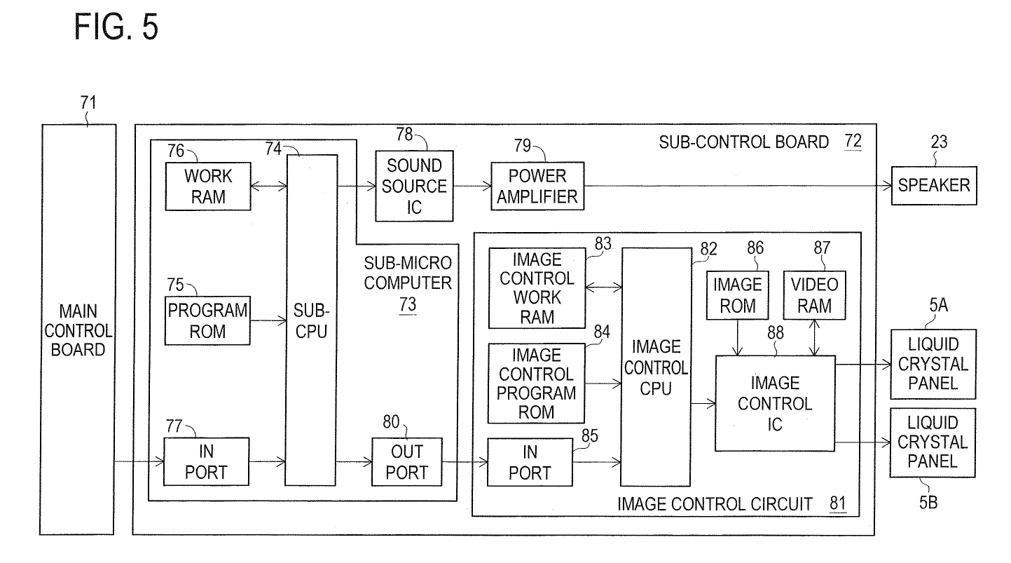

Next, an internal configuration of the gaming machine will be explained by referring to FIGS. 4 and 5.

FIG. 4 is a block diagram showing an internal configuration of the gaming machine 1. As shown in FIG. 4, the gaming machine 1 includes a plurality of components such as a main control board 71 in which a microcomputer 31 is included. The main control board 71 includes the microcomputer 31, a random number generation circuit 35, a sampling circuit 36, a clock pulse generation circuit 37 and a frequency divider 38, and further includes an illumination effect driving circuit 61, a hopper driving circuit 63, a payout completion signal circuit 65 and a printer driving circuit 67.

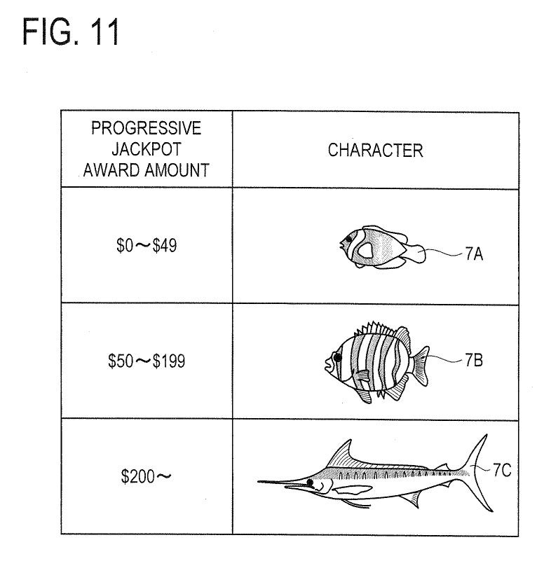

The microcomputer 31 includes a main CPU 32, a RAM 33 and a ROM 34. The main CPU 32 operates in accordance with the program stored in the ROM 34 and performs input and output to and from the other components via an I/O port 39 to carry out an operation control over the gaming machine 1. The RAM 33 stores data or programs to be used during an operation of the main CPU 32. For example, random numbers which are sampled by the after-mentioned sampling circuit 36 are stored temporarily after a start of the game in the RAM 33. The ROM 34 stores programs or static data (a table as shown in FIG. 11, for example).

The programs stored in the ROM 34 include game programs and a game system program (hereinafter referred to as the game program and the like). The game programs further include a lottery program to be used while a game is conducted.

The random number generation circuit 35 is operated in accordance with an instruction of the main CPU 32 and generates random number within a certain range. In accordance with an instruction of the main CPU 32, the sampling circuit 36 extracts any random number from among the random numbers generated by the random number generation circuit 35 and inputs the extracted random number to the main CPU 32. The clock pulse generation circuit 37 generates a reference clock for operating the main CPU 32. The frequency divider 38 inputs a signal obtained by frequency-dividing the reference clock by a certain cycles to the main CPU 32.

A touch panel 101 is connected to the main control board 71. The touch panel 101 is arranged on the front face of the liquid crystal panel 5B and is capable of specifying a position in a coordinate touched by a player, and detecting a portion the player touched and which direction the touched portion has moved in accordance with the specified coordination position information. A signal corresponding to this detection is to be inputted to the main CPU 32 via the I/O port 39.

Further, the operation buttons 11 including the BET button, the game start button, the collect button, the CASHOUT button and the like are connected to the main control board 71. Signals corresponding to pushes of such buttons are inputted to the main CPU 32 via the I/O port 39.

Further, a game communication circuit 102 is connected to the main control board 71. The game communication circuit 102 is a device that converts a signal sent to be sent out by the gaming machine 1 into a signal in a sendable format, according to transmission method of a phone line or a LAN cable, so as to send it to the game server 302. Conversely, the game communication circuit 102 receives a signal sent from the game server 302 to reconvert the signal into a signal in a format readable by the gaming machine 1. The game communication circuit 102 is connected to a server communication circuit 303 via the network 401 of two-way communicable, such as the Internet.

The illumination effect driving circuit 61 outputs an effect signal for carrying out a light illumination effect with the above-described light emitting portion 20 and topper effect device 28. The topper effect device 28 is connected to the illumination effect driving circuit 61 through a serial interface, via the light emitting portion 20.

The hopper driving circuit 63 drives a hopper 64 in accordance with control by the main CPU 32. The hopper 64 conducts an operation for paying out coins and pays out the coins to the coin tray 16. The payout completion signal circuit 65 obtains the numerical value of the number of coins from a coin detection portion 66 connected thereto. When the numerical value reaches the value predetermined set, the payout completion signal circuit 65 inputs a signal for notifying completion of payout of coins into the main CPU 32. The coin detection portion 66 counts the number of coins paid out from the hopper 64 and inputs the number into the payout completion signal circuit 65. The printer driving circuit 67 drives the ticket printer 14 in accordance with control by the main CPU 32.

Further, a sub-control board 72 is connected to the main control board 71. A liquid crystal panel 5A, a liquid crystal panel 5B and the speakers 23 are connected to the sub-control board 72.

FIG. 5 is a block diagram showing an internal configuration of the sub-control board. As shown in FIG. 5, the sub-control board 72 performs display control of the liquid crystal panel 5A and the liquid crystal panel 5B and output control of sound from the speakers 23, by inputting commands from the main control board 71. The sub-control board 72 is arranged on a circuit board which is different from a circuit board constituting the main control board 71. The sub-control board 72 is mainly consisted of a microcomputer (hereinafter referred to as “sub-microcomputer”) 73 and includes a sound source IC 78 for controlling sound outputted from the speakers 23, a power amplifier 79 as an amplifier, and an image control circuit 81 working as display control means for the liquid crystal panels 5A and 5B.

The sub-microcomputer 73 includes a sub-CPU 74 performing control operation in accordance with a control command sent from the main control board 71, a program ROM 75 as memory means, a work RAM 76, and I/O ports 77 and 80. The sub-control board 72 is not provided with a clock pulse generation circuit, a frequency divider, a random number generation circuit and a sampling circuit. However, the sub-control board 72 is configured to perform random number sampling in the operation program of the sub-CPU 74. The program ROM 75 stores a control program executed on the sub-CPU 74. The work RAM 76 is provided as temporal memory means when executing the above control program on the sub-CPU 74.

The image control circuit 81 includes an image control CPU 82, an image control work RAM 83, an image control program ROM 84, an IN port 85, an image ROM 86, a video RAM 87, and an image control IC 88. Based on the parameter set by the sub-microcomputer 73, the image control CPU 82 determines images to be displayed on the liquid crystal panels 5A and 5B, in accordance with the image control program stored in the image control program ROM 84.

The image control program ROM 84 stores an image control program concerning display of the liquid crystal panels 5A and 5B and various selection tables. The image control work RAM 83 is provided as temporal memory means when executing an image control program on the image control CPU 82. The image control IC 88 forms images based on the determination by the image control CPU 82 to output on the liquid crystal panels 5A and 5B.

The image ROM 86 stores dot data for forming an image, for example, dot data on fish characters 7A, 7B and 7C (see FIG. 1). The video RAM 87 works as temporal memory means when forming an image with the image control IC 88.

The image control circuit 81 performs display control on the windows W1 and W2 of the liquid crystal panel 5B (see FIG. 1) based on a control signal from the main CPU 32.

[5. Display of the Liquid Crystal Panel]

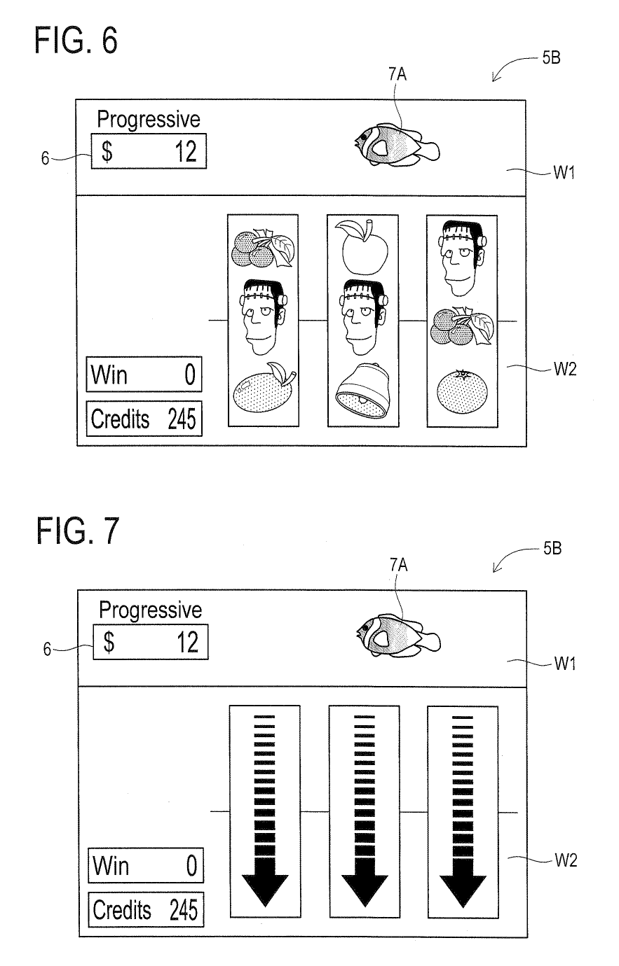

Here will be explained an image to be displayed on the liquid crystal panel 5B. FIGS. 6 through 9 are the views showing one example of images to be displayed on the liquid crystal panel 5B. As shown in FIGS. 6 through 9, the liquid crystal panel 5B is divided into the window W1 and the window W2.

The window W2 of the liquid crystal panel 5B displays an image representing the state of the game being conducted on the gaming machine 1. FIGS. 6 through 9 show images representing the execution state of a video slot game. In FIGS. 6, 8 and 9, video reels are displayed in a stopped state. In FIG. 7, the video reels are displayed in a scrolled state.

Incidentally, an image to be displayed on the window W2 of the liquid crystal panel 5B is not restricted to an image concerning an execution state of a video slot game. That is, the window W2 of the liquid crystal panel 5B displays an image concerning the state of various games executable on the gaming machine 1. Other than slot games, games executable on the gaming machine 1 include card games, roulette games, dice games and mah-jong games, for example.

On the while, the window W1 of the liquid crystal panel 5B is provided with the award amount display portion 6 for displaying progressive jackpot award amount. Additionally, the window W1 displays any one of the fish characters 7A, 7B and 7C.

In FIGS. 6 and 7, the window W1 displays the character 7A of “yellow-tailed anemone fish”. The character 7A of “yellow-tailed anemone fish” is displayed on the window W1 when the numeral on the award amount display portion 6 (progressive jackpot award amount) is $49 or less.

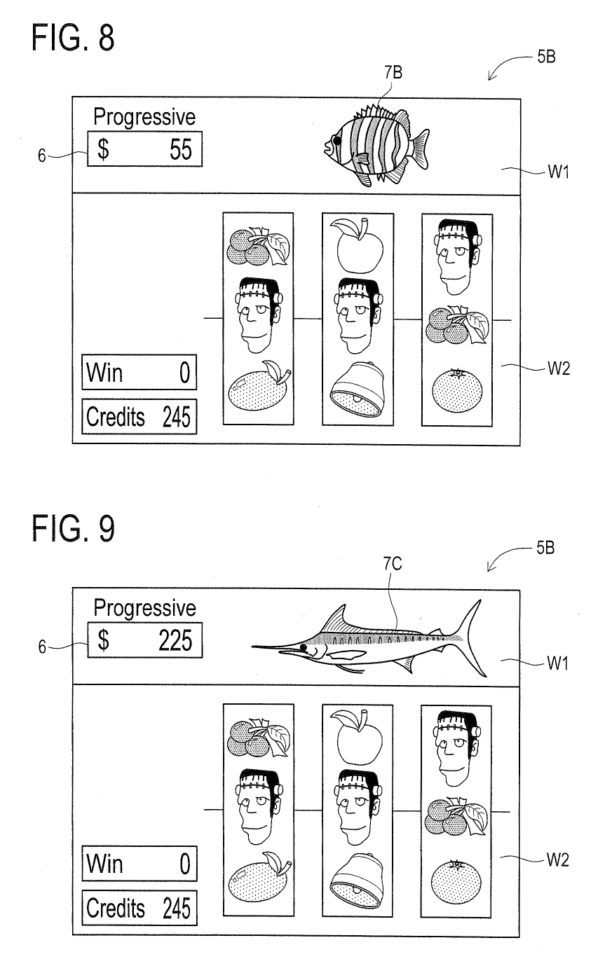

In FIG. 8, the window W1 displays the character 7B of “parrot fish”. The character 7B of “parrot fish” is displayed on the window W1 when the numeral on the award amount display portion 6 (progressive jackpot award amount) is $50 or more and $199 or less.

In FIG. 9, the window W1 displays the character 7C of “blue marlin”. The character 7C of “blue marlin” is displayed on the window W1 when the numeral on the award amount display portion 6 (progressive jackpot award amount) is $200 or more.

In this manner, a fish character to be displayed on the window W1 is changed as the numeral on the award amount display portion 6 (progressive jackpot award amount) increases, by means of the three characters 7A, 7B and 7C respectively representing “yellow-tailed anemone fish ”, “parrot fish” and “blue marlin”. Such display control is conducted by the main CPU 32 (see FIG. 4), based on the table shown in FIG. 11.

[6. Display of the Shared Display]

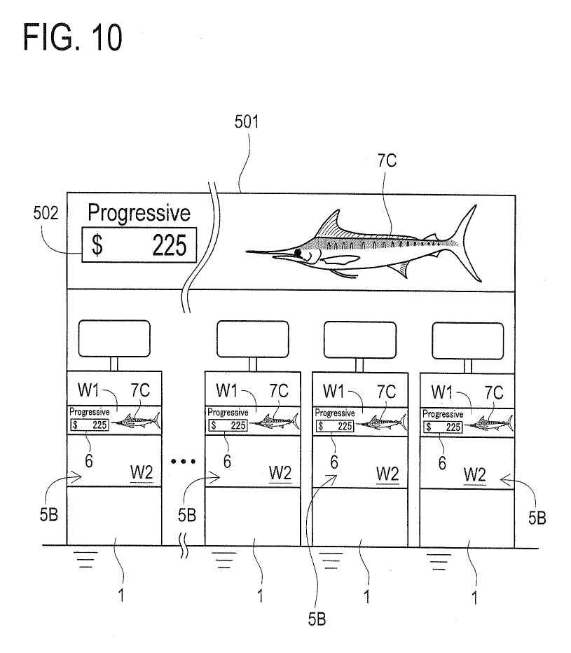

In the gaming system 301 of the present embodiment, as shown in FIG. 10, the shared display 501 displays the same image as displayed on the window W1 of the liquid crystal panel 5B included in the gaming machine 1.

That is, the shared display 501 is provided with an award amount display portion 502 for displaying the progressive jackpot award amount, which corresponds to the award amount display portion 6 provided in the window W1 of the liquid crystal panel 5B included in the gaming machine 1. Further, the shared display 501 displays the same image as displayed on the window W1 of the liquid crystal panel 5B included in the gaming machine 1, from among the fish characters 7A, 7B and 7C.

Accordingly, the character 7A of “yellow-tailed anemone fish” is displayed on the shared display 501 when the number on the award amount display portion 502 (progressive jackpot award amount) is $49 or less. The character 7B of “parrot fish” is displayed on the shared display 501 when the number on the award amount display portion 502 (progressive jackpot award amount) is $50 or more and $199 or less. The character 7C of “blue marlin” is displayed on the shared display 501 when the number on the award amount display portion 502 (progressive jackpot award amount) is $200 or more (see FIG. 1).

As described above, the fish character to be displayed on the shared display 501 is changed as the numeral on the award amount display portion 502 (progressive jackpot award amount) increases, by means of the three characters 7A, 7B and 7C respectively representing “yellow-tailed anemone fish”, “parrot fish” and “blue marlin”. Such display control is conducted by the game server 302 (see FIG. 2), based on the table shown in FIG. 11.

Incidentally, the table shown in FIG. 11 is also stored in the game server 302 (see FIG. 2).

[7. Operation of the Gaming Machine]

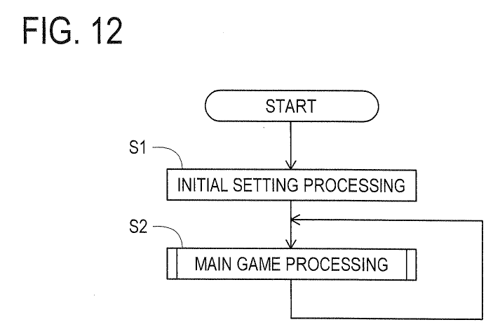

Next, there will be described precisely a main control program to be executed in the gaming machine 1 by referring to the drawings. FIG. 12 is a flowchart of the main control program.

First, when a power switch is turned on (switch-on), the microcomputer 31 is activated and the microcomputer 31 executes an initial setting processing at step (hereinafter referred to as S) 1. In the initial setting processing, the main CPU 32 executes the BIOS stored in the ROM 32 and extracts compressed data included in the BIOS into the RAM 33, thereby to execute the BIOS extracted in the RAM 33 and to carry out diagnosis and initialization of the peripheral devices. Next, the main CPU 32 writes game program and the like read from the ROM 34 to the RAM 33 and obtains payout rate setting data and country identification information. It is to be noted that the main CPU 32 also carries out authentication processing on the programs during the initial setting processing.

In S2, the main CPU 32 sequentially reads out and executes the game program and the like from the RAM 33 thereby to carry out a main game processing. By carrying out the main game processing, a game is conducted in the gaming machine 1. The main game processing is repeatedly carried out while power is supplied to the gaming machine 1.

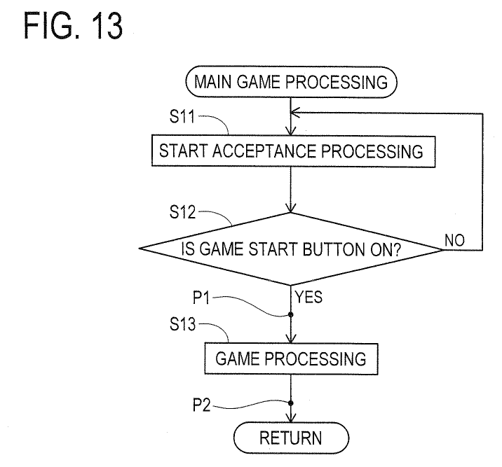

Next, there will be described a subroutine concerning the main game processing of S2 by referring to FIG. 13. FIG. 13 shows the flowchart of the main game processing to be carried out in the gaming machine 1. It is to be noted that the programs indicated in the flowchart are stored in the ROM34 or RAM 33 and executed by the main CPU 32.

As shown in FIG. 13, the main CPU 32 firstly carries out a start acceptance processing at S11. At the start acceptance processing, insertion of a coin and bet operation with the 1-BET button among the operation buttons 11 are done by a player.

Next, in S12, the main CPU 32 judges whether or not a game start button among the operation buttons 11 has been pressed. As to the game start button, a spin button corresponds to it when a video slot is conducted in the gaming machine 1, for example. This judgment is carried out based on a signal to be inputted to the main CPU 32 in response to the press of any one of the operation buttons 11. In case the game start button among the operation buttons 11 is not pressed (S12: NO), the processing returns to the start acceptance processing (S11) again. Under this state, a player can change the number of bets or the like. In case the game start button among the operation buttons 11 is pressed (S12: YES), the main CPU 32 stores the number of bets set by the above bet operation into the RAM 33 as bet information. Next, the processing goes on to S13.

In S13, the main CPU 32 carries out a game processing. At the game processing, the main CPU 32 carries out control for displaying the game state onto the window W2 of the liquid crystal panel 5B by sending a control signal to the sub-control board 72. The main CPU 32 carries out control for changing the execution state of the game being displayed on the window W2 of the liquid crystal panel 5B by sending a control signal to the sub-control board 72 based on the signal to be inputted in response to a press of a button for operating the game among the operation buttons 11.

In this manner, a game proceeds or terminates on the window W2 of the liquid crystal panel 5B. Then, the main CPU 32 awards a payout corresponding to a game result to a player. After that, the main CPU 32 carries out the main game processing shown in FIG. 13.

[8. Operation of the Gaming System]

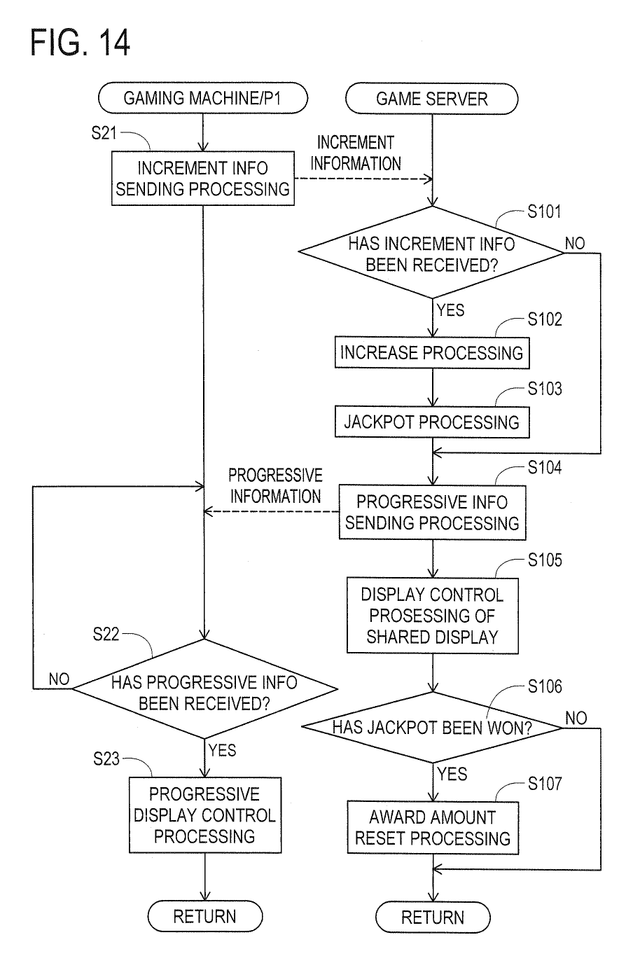

The main CPU 32 carries out processings indicated in S21 through S23 in FIG. 13, at the time of P1 immediately before carrying out the above-described game processing of S13. Here will be explained the processings of S21 through S23 by referring to FIG. 14. It is to be noted that the programs indicated in S21 through S23 of FIG. 14 are stored in the ROM 34 or RAM 33 included in the gaming machine 1 and executed by the main CPU 32.

That is, in case the game start button among the operation buttons 11 is pressed in S12 (S12: YES), the main CPU 32 stores the number of bets set by the bet operation described above into the RAM 33 as bet information and then the processing goes on to S21 shown in FIG. 14.

In S21, the main CPU 32 carries out an increment information sending processing. At the increment information sending processing, the main CPU 32 sends a numerical value corresponding to a certain portion of the number of bets set by the above bet operation as increment information to the game server 302, by referring to the bet information stored in the RAM 33. After that, the processing goes on to S22.

In S22, the main CPU 32 judges whether or not progressive information has been received from the game server 302. This judgment is carried out based on a signal and the like, inputted from the game communication circuit 102 to the main CPU 32 in response to reception of progressive information from the game server 302. Here, the main CPU 32 waits until it receives progressive information from the game server 302 (S22: NO). When progressive information is received from the game server 302 (S22: YES), the processing goes on to S23.

In S23, the main CPU 32 carries out a progressive display control processing. At the progressive display control processing, the main CPU 32 displays the progressive jackpot award amount included in progressive information received from the game server 302 onto the award amount display portion 6 provided in the window W1 of the liquid crystal panel 5B, by sending a control signal to the sub-control board 72. Based on the above-described correspondences shown in FIG. 11, the main CPU 32 selects a character corresponding to the progressive jackpot award amount included in the progressive information received from the game server 302, from among the fish characters 7A, 7B and 7C, to thereby display the selected character onto the window W1 of the liquid crystal panel 5B (for example, see FIG. 10). After that, the processing goes back to the main game processing shown in above FIG. 13.

In the game server 302, processings indicated in S101 through S106 shown in FIG. 14 are carried out. Here will be explained the processings of S101 through S106 by referring to FIG. 14. It is to be noted that the programs indicated in S101 through S106 shown in FIG. 14 are stored in the game server 302 and executed by the game server 302.

In S101, the game server 302 judges whether or not increment information has been received from any one of the gaming machines 1 connected thereto via the network 401. This judgment is carried out based on a signal and the like that the game server communication circuit 303 outputs in response to reception of increment information. In case increment information has not been received (S101: NO), the processing goes on to S104 to be explained below. In case increment information has been received (S101: YES), the processing goes on to S102.

In S102, the game server 302 carries out an increase processing. At the increase processing, the numerical value included in the increment information received from the gaming machine 1 is added to the progressive jackpot award amount. By this processing, the progressive jackpot award amount managed by the game server 302 increases as a certain portion of the number of bets betted on the game conducted in the gaming machine 1 is accumulated.

After the processing goes on to S103, the game server 302 carries out a jackpot processing. At the jackpot processing, the game server 302 determines with a predetermined probability whether or not the gaming machine 1 subject to judgment in the above S101 that sent the increment information wins the progressive jackpot. Then, the processing goes on to S104.

In S104, the game server 302 carries out a progressive information sending processing. At the progressive information sending processing, the game server 302 sends progressive information which includes the progressive jackpot award amount to the gaming machine 1 connected to the game server 302 via the network 401. In case it is determined that the progressive jackpot has been won, the game server 302 also incorporates data for notice of winning of the progressive jackpot into progressive information to be sent back to the gaming machine 1 subject to judgment in the above S101 that sent the progressive information. After that, the processing goes on to S105.

In S105, the game server 302 carries out a display control processing of shared display. At the display control processing of shared display, the game server 302 displays progressive jackpot award amount onto the award amount display portion 502 provided in the shared display 501. Based on the above-described correspondences shown in the table of FIG. 11, the game server 302 selects a character corresponding to the progressive jackpot award amount, from among the fish characters 7A, 7B and 7C, to thereby display the selected character onto the shared display 501 (see FIG. 10 above). After that, the processing goes onto S106.

In S106, the game server 302 judges whether or not the progressive jackpot has been won by any one of the gaming machines 1. This judgment is carried out based on the processing result of S103 above. In case the progressive jackpot has not been won (S106: NO), the control programs indicated in FIG. 14 are executed by returning to S101. In case the progressive jackpot has been won (S106: YES), the processing goes on to S107.

In S107, the game server 302 carries out an award amount reset processing. At the award amount reset processing, the game server 302 resets the progressive jackpot award amount to ‘0’. After that, the processing returns to S101 and the control programs indicated in FIG. 14 are executed.

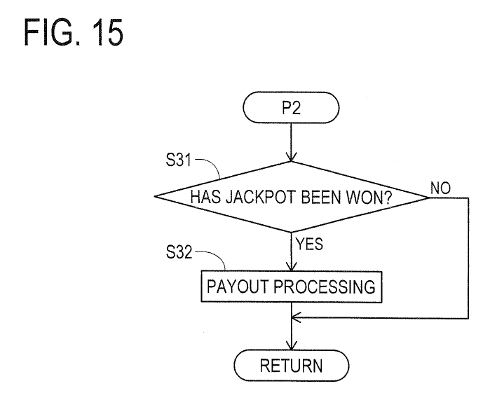

In the gaming machine 1, the main CPU 32 carries out processings indicated in S31 through S32 in FIG. 15, at the time of P2 after carrying out of the game processing of S13. Here will be explained the processings of S31 through S32 by referring to FIG. 15. It is to be noted that the programs indicated in S31 through S32 are stored in the ROM 34 or RAM 33 provided in the gaming machine 1 and are executed by the main CPU 32.

In other words, the main CPU 32 proceeds to execution of S31 in FIG. 15 after carrying out the game processing of above-described S13.

In S31, the main CPU 32 judges whether or not the gaming machine 1 has won the progressive jackpot. This judgment is carried out based on the progressive information received from the game server 302. In case the gaming machine 1 has not won the progressive jackpot (S31: NO), the processing goes back to the above-described main game processing in FIG. 13. In case the gaming machine 1 has won the progressive jackpot (S31: YES), the processing goes on to S32.

In S32, the main CPU 32 carries out a payout processing. At the payout processing, the main CPU 32 awards the progressive jackpot award amount included in the progressive jackpot information received from the game server 302 to a player. After that, the main CPU 32 goes back to the above-described main game processing of FIG. 13 above.

[9. Others]

It is to be noted that the present invention is not limited to the above described embodiment and may be modified in various ways within a scope not departing from the present invention.

For example, in the gaming system 301 of the present embodiment, the fish characters 7A, 7B and 7C which are displayed on the window W1 of the liquid crystal panel 5B provided in the gaming machine 1 or the shared display 501 can be displayed in either manner of still image or moving image.

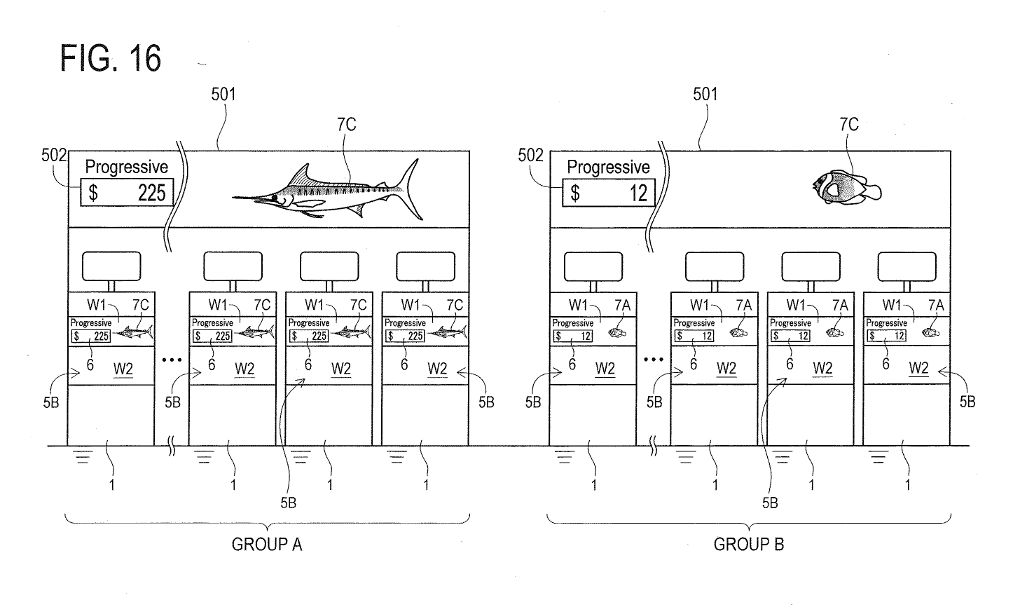

Optionally, the gaming system 301 of the present embodiment can be divided into a plurality of groups consisted of a certain number of gaming machines 1. In this case, a shared display 501 is to be provided for each group. The game server 302 manages progressive jackpots for each of the groups. Incidentally, FIG. 16 shows an exemplary case where the gaming system 301 of the present embodiment is divided into two groups A and B, respectively consisted of a certain number of gaming machines 1.

Also, the gaming system 301 of the present embodiment can be applied not only to what is called “linked progressive” which is set up in a single game arcade, but also to what is called “wide area progressive” which is set up over a plurality of game arcades.

Also, in the gaming system 301 of the present embodiment, the characters 7A, 7B and 7C displayed on the window W1 of the liquid crystal panel 5B provided in the gaming machine 1 or the shared display 501 are not restricted to the above-described fish characters such as “yellow-tailed anemone fish”, “parrot fish” and “blue marlin”.

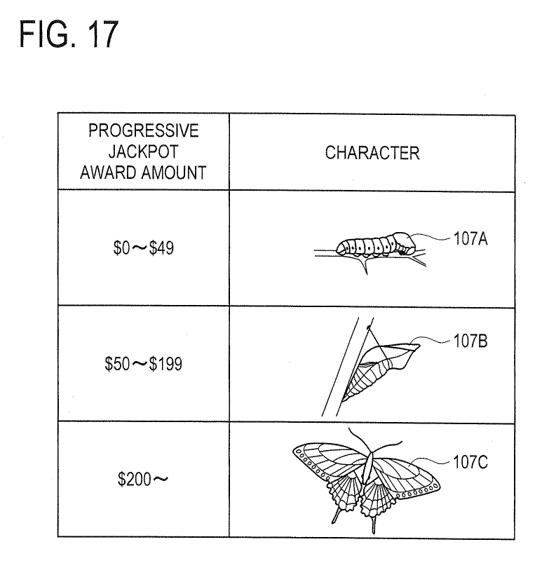

For example, objects at metamorphic stages appearing in the course of development of butterflies can be employed, as shown in correspondences in FIG. 17.

That is, according to the correspondences shown in the table of FIG. 17, when the numeral on the award amount display portion 6 or the award amount display portion 502 (progressive jackpot award amount) indicate $49 or less, the window W1 of the liquid crystal panel 5B provided in the gaming machine 1 and the shared display 501 displays a character 107A of “butterfly larva”. When the numeral on the award amount display portion 6 and the award amount display portion 502 (progressive jackpot award amount) indicate than $50 or more and $199 or less, the window W1 of the liquid crystal panel 5B provided in the gaming machine 1 or the shared display 501 displays a character 107B of “butterfly pupa”. When the numeral on the award amount display portion 6 and the award amount display portion 502 (progressive jackpot award amount) indicates $200 or more, the window W1 of the liquid crystal panel 5B provided in the gaming machine 1 or the shared display 501 displays a character 107C of “adult butterfly”. It is to be noted that these butterfly characters 107A, 107B and 107C can be displayed in either manner of still image or moving image.

Also, any one of the gaming machines 1 connected to the network 401 can be used as the game server 302.

Also, the above-described control technique which displays the progressive jackpot award amount and the character in pair can be applied to progressive jackpot in which the gaming machine 1 independently manages a progressive jackpot (what is called “stand alone”).

What is claimed is:

1. A gaming machine comprising:
an operation device for carrying out bet operation on a game;
a display in which a progressive jackpot award amount and a character are displayed in pair; and
a processor programmed to carry out operations of:
(a) incrementing the progressive jackpot award amount in accordance with number of bets betted with the operation device; and
(b) changing the character displayed on the display in accordance with the progressive jackpot award amount, which has been incremented at (a).

2. The gaming machine according to claim 1,
wherein, in carrying out the operation of (b), the processor changes the character in phases, in proportion as the progressive jackpot award amount increases.

3. The gaming machine according to claim 1,
wherein, in carrying out the operation of (b), the processor makes the character developed in phases, in proportion as the progressive jackpot award amount increases.

4. A gaming system, comprising:
a plurality of gaming machines each of which includes:
an operation device for carrying out bet operation on a game; and
a display in which a progressive jackpot award amount and a character are displayed in pair; and
a server that configures each of the plurality of gaming machines to share the progressive jackpot, the server being programmed to carry out operations of
(a) incrementing the progressive jackpot award amount in accordance with number of bets betted in each of the plurality of gaming machines by using the operation device;
(b) changing the character displayed on the display of each of the plurality of gaming machines, in accordance with the progressive jackpot award amount, which has been incremented at (a).

5. The gaming system according to claim 4,
wherein, in carrying out the operation of (b), the server changes the character in phases, in proportion as the progressive jackpot award amount increases.

6. The gaming system according to claim 4,
wherein, in carrying out the operation of (b), the server makes the character developed in phases, in proportion as the progressive jackpot award amount increases.

7. A gaming system, comprising:
a shared display;
a plurality of gaming machines each of which includes:
an operation device for carrying out bet operation on a game; and
a display in which a progressive jackpot award amount and a character are displayed in pair; and
a server that configures each of the plurality of gaming machines to share the progressive jackpot, the server being programmed to carry out operations of
(a) incrementing the progressive jackpot award amount in accordance with number of bets betted in each of the plurality of gaming machines by using the operation device,
(b) changing the character displayed on the display of each of the plurality of gaming machines, in accordance with the progressive jackpot award amount, which has been incremented at (a), and
(c) displaying the progressive jackpot award amount, which has been incremented at (a), and the character, which has been changed at (b), in pair onto the shared display.

8. The gaming system according to claim 7,
wherein, in carrying out the operation of (b), the server changes the character in phases, in proportion as the progressive jackpot award amount increases.

9. The gaming system according to claim 7,
wherein, in carrying out the operation of (b), the server makes the character developed in phases, in proportion as the progressive jackpot award amount increases.
